(19) United States
(12) Patent Application Publication
(10) Pub. No.: US 2015/0099544 A1
(43) Pub. Date: Apr. 9, 2015

(54) MOBILE PHONE APPLICATION FOR ROUTING TO A PERSON FOR PICK-UP RETRIEVAL

(71) Applicant: Panasonic Automotive Systems Company of America, Division of Panasonic Corporation of North America, Peachtree City, GA (US)

(72) Inventor: RICHARD FAY, Newman, GA (US)

(73) Assignee: Panasonic Automotive Systems Company of America, Division of Panasonic Corporation of North America, Peachtree City, GA (US)

(21) Appl. No.: 14/046,286

(22) Filed: Oct. 4, 2013

(51) Int. Cl. H04W 4/02; G01C 21/34; G01C 21/36

(52) U.S. Cl. CPC H04W 4/023; G01C 21/3667; G01C 21/362; G01C 21/3438
USPC 455/456.2

(57) ABSTRACT

A navigation method includes the following computer-implemented steps. A target mobile electronic device is identified. A geographical location of the target mobile electronic device is ascertained. Information is transmitted to a sender mobile electronic device. The information identifies the geographical location of the target mobile electronic device. A route along roadways from the sender mobile electronic device to the geographical location of the target mobile electronic device is determined. The determining step is dependent upon the information.

### BACKGROUND OF THE INVENTION

1. Field of the Invention

The present invention relates to a location based services, and, more particularly, to locating and navigating to a mobile electronic device.

2. Description of the Related Art

Existing location based services show locations but do not provide navigation directions to the locations from a particular starting point. Particularly, existing location based services do not integrate routing services with a simple selection function.

### SUMMARY OF THE INVENTION

The invention may provide a software application that works in conjunction with global positioning system (GPS) navigation systems and cell phones. When using a GPS system, if the user (e.g., sender) wants to navigate to a target cell phone at the target's current location, the user enters into the sender cell phone the identity of the target cell phone to be navigated to. A proxy for the target's identity may be entered, such as the target's phone number. In response, the application running on the sender cell phone displays the location of the target, and calculates a route from the sender to the target or local area that the target may be in. Upon receiving the calculated route, the user is enabled to find his way to the area in which the target is currently located. Alternately, a phone call may be currently in progress between the user and the owner of the target cell phone. The user can initiate authentication, obtain target location, calculate the routing function to the target, and activate turn-by-turn and display functions to take the user to the target by initiating this application, while the call is in-progress. The requesting user may be authenticated to ensure that the owner of the target approves of the requesting user receiving the location of the target, and to protect the privacy of the owner of the target. In order to establish the location of the target, GPS may be employed if the target is GPS enabled; the system may determine the location of a WiFi network server that is in communication with the target; or the system may determine the location of the nearest cell tower that is in communication with the target.

The invention comprises, in one form thereof, a navigation method including the following computer-implemented steps. First information identifying a target mobile electronic device is provided by a sender mobile electronic device A geographical location of the target mobile electronic device is ascertained. Information is transmitted to a sender mobile electronic device. The information identifies the geographical location of the target mobile electronic device. A route along roadways from the sender mobile electronic device to the geographical location of the target mobile electronic device is determined. The determining step is dependent upon the information.

The invention comprises, in another form thereof, a navigation method including the following computer-implemented steps. First information identifying a target mobile electronic device is provided by a sender mobile electronic device. A geographical location of the target mobile electronic device is ascertained. It is verified that the sender mobile electronic device is permitted to be informed of the geographical location of the target mobile electronic device. Second information is transmitted to the sender mobile electronic device. The second information identifies the geographical location of the target mobile electronic device. The transmitting step is performed dependent upon the verifying step. A surface navigation route from the sender mobile electronic device to the geographical location of the target mobile electronic device is determined dependent upon the second information.

The invention comprises, in yet another form thereof, a navigation method including the following computer-implemented steps. First information identifying a target mobile electronic device is provided by a sender mobile electronic device A geographical location of the target mobile electronic device is ascertained by a geographic positioning system within the target mobile electronic device. Information is transmitted to a sender mobile electronic device. The information identifies the geographical location of the target mobile electronic device. A navigation route from the sender mobile electronic device to the geographical location of the target mobile electronic device is determined by use of the information.

An advantage of the present invention is that it may enable a requesting user to receive directions to the current location of a target cell phone merely by providing the telephone number of the target cell phone or some other identifying information for the target phone or the person associated with the target phone.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a locating system of the present invention.

FIG. 2 is a block diagram of another embodiment of a navigation system of the present invention.

FIG. 3 is a flow chart of one embodiment of a navigation method of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

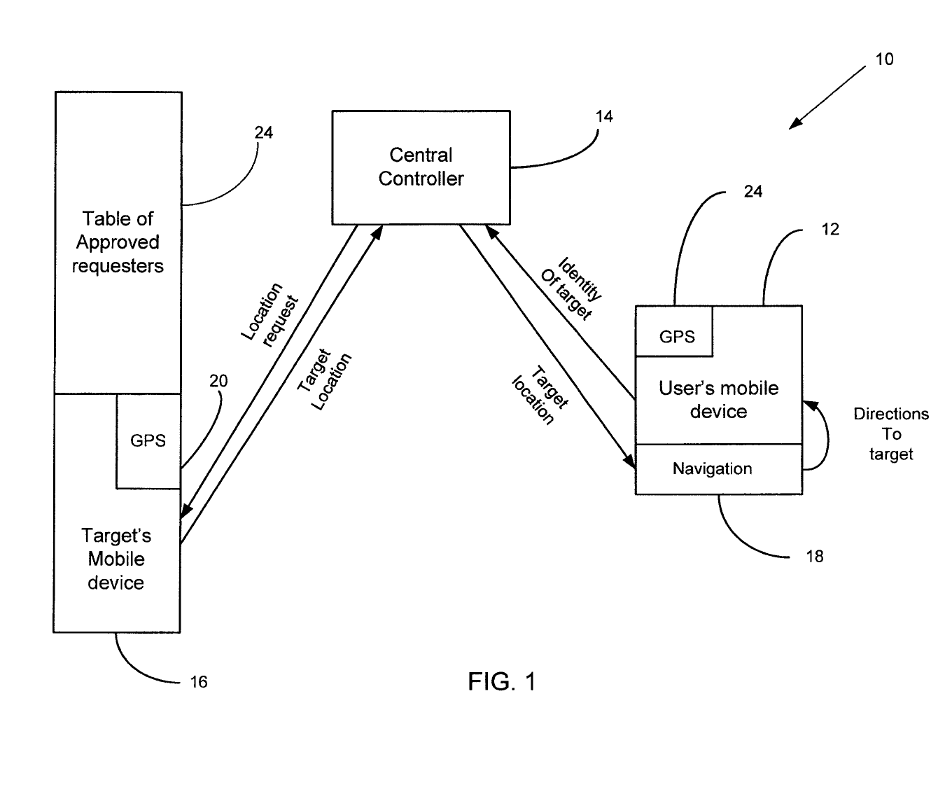

FIG. 1 is a block diagram of one embodiment of a locating system 10 of the present invention, including a sender mobile device 12, a central controller 14 and a target mobile device 16. The sender mobile device 12 may include a navigation system 18 which may provide the user with directions and driving routes to reach a desired location, as is well known. Sender mobile device 12 and/or navigation system 18 may be permanently installed in, or connected to, a motor vehicle owned by the user.

Central controller 14 may be a conventional cellular tower system that enables the sender mobile device 12 to communicate substantially directly with the target mobile device 16. Central Controller 14 may not include any dedicated software to support the present invention. Thus, the present invention may function autonomously through the existing cellular infrastructure. The existing cell infrastructure currently supports GPS location enhancement. The target mobile device 16 may include a GPS 20 which may inform device 16 of its location (e.g., geographical coordinates) as requested at any point in time.

During use, the user of sender mobile device 12 may open the application which may be stored with device 12. The application may be initiated solely by the user identifying the target mobile device whose location is to be determined. For example, the user may provide the name or phone number of the person who owns or uses the target mobile device, or may click on the person's name from his contact list. The identity of the target mobile device may be transmitted in a request to central controller 14. If central controller 14 includes only one or more base stations, the request is forwarded to the target mobile device 16. Alternatively, when the application is opened, the user may already be conversing via mobile devices 12, 16 with the person associated with target device 16. Thus, mobile device 16 may be automatically identified as the target by virtue of being involved in the telephone call.

The application may also be installed in mobile device 16. Upon receiving the request, which may include the identity of sender device 12 or of the requesting user of sender device 12, target device 16 may verify that the requesting user is someone that the person who owns target device 16 wants to know the location of the target device 16. The owner of target device 16 may personally authorize each requester or sender device 12 on a case-by-case basis, or the target mobile device 16 may include a table 24 of pre-approved requesters or sender devices 12 in order for target mobile device 16 to verify that the requester or sender device 12 is on the list. In an embodiment wherein central controller 14 has processing power, central controller 14 may consult a table 24 of pre-approved requesters or sender devices 12 in order to verify that the requester or sender device 12 is on the list.

If the requester or sender device 12 is not on the pre-approved list, or otherwise is not authorized by the target device 16, then the location of the target device 16 is not transmitted to the sender device 12. If, on the other hand, the requester or sender device 12 is on the pre-approved list, or otherwise is authorized by the target device 16, then the location of the target device 16 is transmitted from target device 16 to the requesting sender mobile device 12 through central controller 14.

In another embodiment, the target mobile device 16 does not include a GPS. In this case, it may not be possible to determine an exact location of target mobile device 16. However, central controller 14 may determine which base station is closest to target mobile device 16, and the location of this closest base station, like the locations of all the base stations, may be known by central controller 14. Thus, the location of the base station that is closest to target mobile device 16 may serve as an approximation of the location of target mobile device 16. Accordingly, central controller 14 may transmit to sender mobile device 12 the location of the base station that is closest to target mobile device 16.

Regardless of how the sender mobile device 12 receives the location of the target mobile device 16, sender mobile device 12 may use its GPS 24 and the location of the target mobile device 16 to determine a route and/or turn-by-turn directions from sender device 12 to target device 16. As is conventionally known, sender mobile device 12 may transmit the location of sender device 12 and its desired destination (i.e., the location of target mobile device 16) to a remote server that calculates an optimal (e.g., shortest and/or quickest) route and directions and transmits the same back to navigation system 18 of sender device 12. Alternatively, sender device 12 and navigation system 18 may have enough route data to perform its own calculations of the optimal route and turn-by-turn directions.

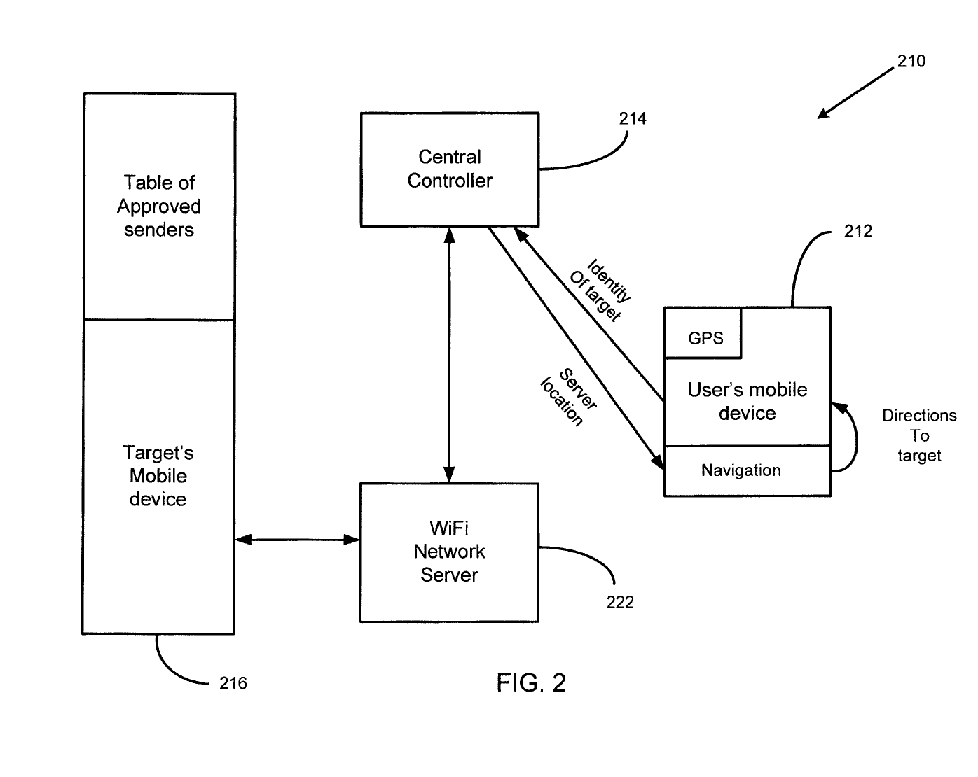

In yet another embodiment of a locating system 210 (FIG. 2) of the present invention, the target mobile device 216 does not include a GPS and communicates with central controller 214 via a WiFi network server 222. Again, without a GPS, it may not be possible to determine an exact location of target mobile device 216. However, central controller 214 may determine, or may have predetermined, the location of WiFi network server 222. Thus, the location of WiFi network server 222 may serve as an approximation of the location of target device 216. Accordingly, central controller 214 may transmit to sender mobile device 212 the location of WiFi network server 222. Other features of system 210 are substantially similar to those of system 10 described above, and thus are not described herein in order to avoid needless repetition.

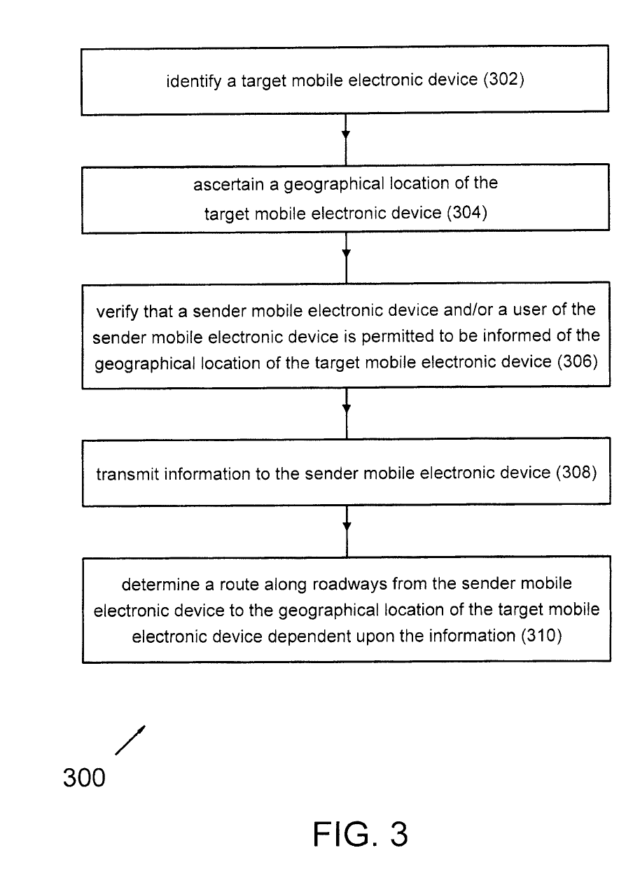

One embodiment of a navigation method 300 of the present invention is shown in FIG. 3. In a first step 302, a target mobile electronic device is identified. For example, information identifying a user of a target mobile electronic device 16 is received. A user of sender mobile electronic device 12 may enter into sender device 12 the name (e.g., “John Smith”), user name, or some other information identifying a person to whom the user of sender mobile electronic device 12 wishes to navigate to. Alternatively, a user of sender mobile electronic device 12 may enter into sender device 12 the telephone number of target mobile electronic device 16. Sender device 12 may then transmit the identification information entered by the user to central controller 14, which receives the transmitted identification information. Next, the target mobile electronic device 16 is identified by use of the identity of the owner of target device 16, or by the use of the telephone number of target device 16. That is, central controller 14 may refer to a list or database that relates the identities, telephone numbers and/or addresses of mobile electronic devices to the identities of the users of the devices. Thus, central controller 14 may refer to the list or database to identify target mobile device 16 based on the identity of the owner of device 16. For example, controller 14 may refer to the list or database to determine that the identified user, John Smith, is the user of a mobile electronic device having a telephone number of 317-555-5555. Alternatively, a telephone number provided by sender device 12 may be used to directly identify target device 16.

In another embodiment, the target mobile electronic device is identified as being the device that that the sender mobile electronic device is in communication with in a telephone call that is already in progress when the application of the present invention is initiated. Thus, the identity of the owner of the target mobile electronic device is not needed in order to identify the target mobile electronic device.

In a next step 304, a geographical location of the target mobile electronic device is ascertained. For example, central controller 14 may telecommunicate with target mobile device 16 and request that target device 16 report its geographical location. In response, target device 16 may determine its current location by use of GPS 20 within target device 16, and target device 16 may transmit its geographical location to controller 14. Alternatively, if target device 16 does not include a GPS, then controller 14 may determine a location of a WiFi network server 222 used by target device 16, and the location of server 222 may be used as a proxy for the location of target device 16. As another alternative, if target device 16 does not include a GPS, then controller 14 may determine a closest cell tower that is a being used by target device 16, and the location of the cell tower may be used as a proxy for the location of target device 16. In another embodiment, a more exact location of target device 16 may be determined via triangulation by estimating the distances between target device 16 and the three closest cell towers, which distances may be determined based on the strengths of signals exchanged between target device 16 and the three closest cell towers.

In step 306, it is verified that a sender mobile electronic device and/or a user of the sender mobile electronic device is permitted to be informed of the geographical location of the target mobile electronic device. For example, having been informed of the identity of the user of sender mobile device 12, the user of target mobile device 16 (e.g., John Smith), may approve or disapprove of the sender mobile device 12 and/or a user of sender mobile device 12 being informed of the location of target mobile device 16. Alternatively, central controller 14 and/or target mobile device 16 may consult table 24 to thereby determine whether sender mobile device 12 and/or a user of sender mobile device 12 are on a list of entities who are pre-approved to receive the location of target mobile device 16.

Next, in step 308, information is transmitted to a sender mobile electronic device. The information identifies the geographical location of the target mobile electronic device. The transmitting step is performed dependent upon the verifying step. That is, the ascertained geographical coordinates of target mobile device 16 may be transmitted from controller 14 to sender mobile device 12 only if it has been verified that sender mobile device 12 and/or a user of sender mobile device 12 is permitted to be informed of the geographical location of target mobile device 16.

In a final step 310, a route along roadways from the sender mobile electronic device to the geographical location of the target mobile electronic device is determined dependent upon the information. For example, navigation system 18 of sender mobile device 12 may calculate a route from the location of sender device 12, as determined by GPS 24, to the location of target device 16, as transmitted to sender device 12.

In any of the above-described embodiments, the determination of the navigation route from the sender mobile electronic device to the target mobile electronic device may be supplemented or followed by the production of interactive turn-by-turn instructions corresponding to the determined route. The producing may include the use of cloud based routing engine and cloud-based voice recognition or phone service-based routing engine and voice recognition resources. This may enable users with or without smart phones or sophisticated displays to subscribe to a service that could help them find each other, despite the limitations of their personal electronic devices. For example, even without a GPS receiver on either the sender device or the target device, the users may find each other by use of the devices and cell towers or any other means available, which may include visual location information input from either user of the sender or target mobile electronic devices. The visual location information input may include verbally identifying street signs, addresses, etc., to cloud-based or phone service based voice recognition resources.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A navigation method, comprising the computer-implemented steps of:
identifying a target mobile electronic device;
ascertaining a geographical location of the target mobile electronic device;
transmitting information to a sender mobile electronic device, the information identifying the geographical location of the target mobile electronic device; and
determining a route along roadways from the sender mobile electronic device to the geographical location of the target mobile electronic device, the determining step being dependent upon the information.

2. The method of claim 1 wherein the determining is at least partially performed within the sender mobile electronic device.

3. The method of claim 1 comprising the further step of ascertaining a geographical location of the sender mobile electronic device by use of a geographic positioning system within the sender mobile electronic device.

4. The method of claim 1 comprising the further step of verifying that the sender mobile electronic device is authorized to receive the information.

5. The method of claim 1 wherein the step of ascertaining a geographical location of the target mobile electronic device is performed by use of a geographic positioning system within the target mobile electronic device.

6. The method of claim 1 comprising the further step of producing interactive turn-by-turn instructions corresponding to the determined route, the producing including use of cloud-based routing engine resources and cloud-based voice recognition or phone service-based voice recognition.

7. A navigation method, comprising the computer-implemented steps of:
providing first information identifying a target mobile electronic device, the providing being performed by a sender mobile electronic device;
ascertaining a geographical location of the target mobile electronic device;
verifying that the sender mobile electronic device is permitted to be informed of the geographical location of the target mobile electronic device;
transmitting second information to the sender mobile electronic device, the second information identifying the geographical location of the target mobile electronic device, the transmitting step being performed dependent upon the verifying step; and
determining a surface navigation route from the sender mobile electronic device to the geographical location of the target mobile electronic device, the determining step being dependent upon the second information.

8. The method of claim 7 wherein the determining is at least partially performed within the sender mobile electronic device.

9. The method of claim 7 comprising the further step of ascertaining a geographical location of the sender mobile electronic device by use of a geographic positioning system within the sender mobile electronic device.

10. The method of claim 7 wherein the step of ascertaining a geographical location of the target mobile electronic device is performed by use of a geographic positioning system within the target mobile electronic device.

11. The method of claim 7 comprising the further step of producing interactive turn-by-turn instructions corresponding to the determined route, the producing including use of cloud-based routing engine resources and cloud-based voice recognition or phone service-based voice recognition.

12. A navigation method, comprising the computer-implemented steps of:
identifying a target mobile electronic device;
ascertaining a geographical location of the target mobile electronic device, the ascertaining being performed by a geographic positioning system within the target mobile electronic device;
transmitting information to a sender mobile electronic device, the information identifying the geographical location of the target mobile electronic device; and
determining a navigation route from the sender mobile electronic device to the geographical location of the target mobile electronic device, the determining step being performed by use of the information.

13. The method of claim 12 wherein the information comprises first information, the method comprising the further step of receiving second information identifying the target mobile electronic device.

14. The method of claim 12 wherein the determining step is performed by a navigation system within the sender mobile electronic device.

15. The method of claim 12 wherein the second information identifying the target mobile electronic device is transmitted by the sender mobile electronic device.

16. The method of claim 12 comprising the further step of ascertaining a geographical location of the sender mobile electronic device by use of a geographic positioning system within the sender mobile electronic device.

17. The method of claim 12 comprising the further step of verifying that the sender mobile electronic device is authorized to receive the first information.

18. The method of claim 12 wherein the step of ascertaining a geographical location of the target mobile electronic device is performed by use of a geographic positioning system within the target mobile electronic device.

19. The method of claim 12 comprising the further step of producing interactive turn-by-turn instructions corresponding to the determined route.

20. The method of claim 19 wherein the producing includes use of cloud-based routing engine resources and cloud-based voice recognition or phone service-based voice recognition.
